(19) United States
(12) Patent Application Publication
(10) Pub. No.: US 2026/0186933 A1
(43) Pub. Date: Jul. 2, 2026

(54) SYSTEM AND METHOD FOR AUTOMATED TESTING

(71) Applicant: Aivres Systems Inc., San Jose, CA (US)

(72) Inventor: Po Yen HUANG, Taoyuan City (TW)

(21) Appl. No.: 19/005,194

(22) Filed: Dec. 30, 2024

(51) Int. Cl. G06F 11/26; G06F 11/22

(52) U.S. Cl. CPC G06F 11/26; G06F 11/2268

(57) ABSTRACT

A method to perform automated testing of a server, is provided. The method retrieves a plurality of server tests associated with the server from a database, and a first list of material items installed on the server from a controller associated with the server. The method executes each server test of the plurality of server tests to generate a plurality of test results and compares the plurality of test results with a plurality of expected results to create a plurality of comparison results. The plurality of test results and the plurality of comparison results are stored in the database. A test report is generated based on the plurality of test results and the plurality of comparison results. The automated testing of the server is terminated based on a test completion status and a test completion time recorded at the controller.

### FIELD

The present disclosure relates to an automated component testing system.

### BACKGROUND

Reliability and performance of system components—such as processors, memory, storage, and network interfaces—are critical to modern enterprise operations. However, manual testing of these components can be complex, time-consuming, and inefficient. Configuring test environments, executing test cases, and analyzing results require significant expertise and effort, making the process prone to human error and inconsistencies.

As system architectures grow more complex, manual testing struggles to scale, particularly in large data centers managing numerous systems. This approach delays issue detection, hampers system reliability, and lacks the automation needed for consistent, repeatable testing.

### SUMMARY

A first aspect of the present disclosure provides a method to perform automated testing of a server. The method includes retrieving a plurality of server tests associated with the server from a database, retrieving a first list of material items installed on the server from a controller associated with the server, executing each server test of the plurality of server tests to generate a plurality of test results, comparing the plurality of test results with a plurality of expected results to create a plurality of comparison results, storing the plurality of test results and the plurality of comparison results in the database, generating a test report based on the plurality of test results and the plurality of comparison results, and terminating the automated testing of the server based on a test completion status and a test completion time recorded at the controller.

A second aspect of the present disclosure provides a system to perform automated testing of a server. The system includes a controller configured to: retrieve a plurality of server tests associated with the server from a database, retrieve a first list of material items installed on the server from a controller associated with the server, execute each server test of the plurality of server tests to generate a plurality of test results, compare the plurality of test results with a plurality of expected results to create a plurality of comparison results, store the plurality of test results and the plurality of comparison results in the database, generate a test report based on the plurality of test results and the plurality of comparison results, and terminate the automated testing of the server based on a test completion status and a test completion time recorded at the controller.

A third aspect of the present disclosure provides a tangible, non-transitory computer-readable medium to perform automated testing of a server, the computer-readable medium having instructions thereon, which, upon being executed by one or more processors, provides for execution of the following steps: retrieving a plurality of server tests associated with the server from a database, retrieving a first list of material items installed on the server from a controller associated with the server, executing each server test of the plurality of server tests to generate a plurality of test results, comparing the plurality of test results with a plurality of expected results to create a plurality of comparison results, storing the plurality of test results and the plurality of comparison results in the database, generating a test report based on the plurality of test results and the plurality of comparison results, and terminating the automated testing of the server based on a test completion status and a test completion time recorded at the controller.

### BRIEF DESCRIPTION OF THE DRAWINGS

Systems and methods for automated component testing are described in detail below with reference to the attached drawing figures, wherein:

FIG. 1 illustrates a block diagram of a system, according to one or more embodiments of the present disclosure.

FIG. 2 illustrates a block diagram illustrating an automated testing system, according to one or more embodiments of the present disclosure.

FIG. 3 illustrates a method for automated testing of systems, according to one or more embodiments of the present disclosure.

### DETAILED DESCRIPTION

The following detailed description is merely exemplary in nature and is not intended to limit the disclosure or the application and uses of disclosed embodiments and methods. Furthermore, there is no intention to be bound by any expressed or implied theory presented in the preceding background, summary, brief description of the drawings or the description that follows.

Manual testing of system components is complex, time-intensive, and prone to human error. As system architectures grow more sophisticated, the manual testing approach struggles to scale, delaying issue detection and compromising reliability. An efficient, automated solution is needed to streamline testing, improve accuracy, and enhance system performance.

Embodiments of the present disclosure provide systems and methods directed to automated testing of systems. According to embodiments of the present disclosure, a testing system is configured to perform automated testing of a system. The testing system communicates with a system to be tested, that is independent of the testing system, using a communications protocol, examples of which include Redfish, Intelligent Platform Management Interface (IPMI), or Simple Network Management protocol (SNMP).

In some embodiments, the system includes a controller, such as a baseboard management controller (BMC). A BMC is a specialized microcontroller embedded in a system's motherboard and leverages a communication protocol for hardware management and monitoring, independent of the host operating system. This allows for remote diagnosis and repair even when the operating system is unresponsive or the system crashes. BMCs utilize various communication protocols, including IPMI, Redfish, and SNMP, to interface with management systems. SNMP is an example of a protocol that is useful for system management, enabling efficient communication with the BMC for sensor data collection, system status monitoring, event notifications, system event logs, remote management, and configuration tasks. Its ability to provide rapid, reliable updates and facilitate seamless remote interactions makes SNMP an efficient means of communication with system hardware. Although embodiments herein are generally described in connection with SNMP, it will be understood that any suitable protocol may used.

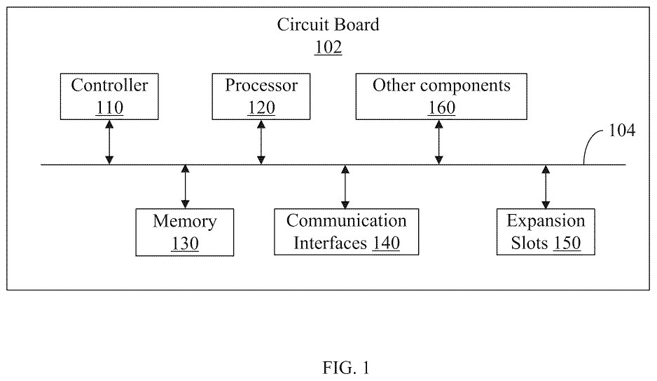

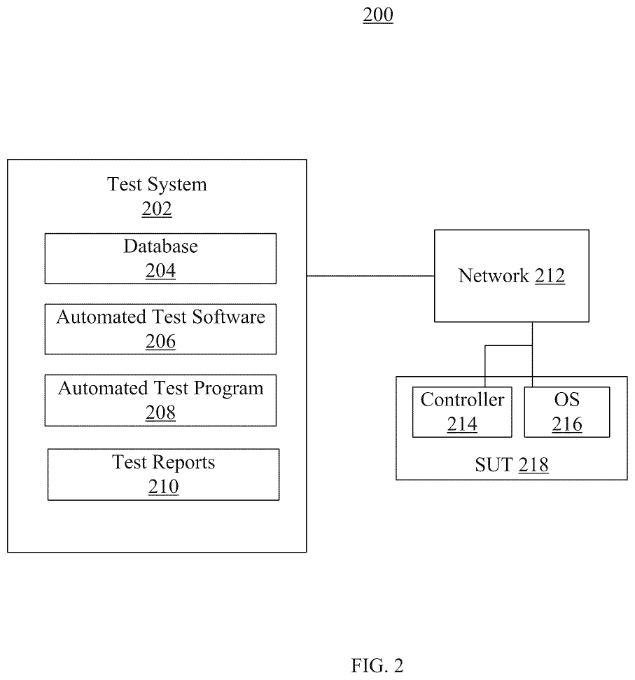

FIG. 1 illustrates a block diagram of a system 100, e.g., server, suitable for use in implementing embodiments of the present disclosure. In some embodiments, the system 100 may be an automated testing system and/or the system under test, as described with respect to FIG. 2. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed components or devices, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the server system 100 falls within the scope and intent of the disclosed embodiments. The server system 100 can be housed in a rack-mounted chassis designed for optimal airflow and cooling, ensuring efficient heat dissipation during operation. Yet further, a person skilled in the art will recognize that the systems and methods described herein can be used with computer systems other than server systems.

The system 100 typically includes one or more circuit boards, e.g., a motherboard 102, that may carry various components, including hardware, firmware, and/or software, which may be integrated with, attached to, connected to, or in communication with the motherboard. As shown in FIG. 1, the motherboard 102 carries at least one controller 110, such as a baseboard management controller (BMC), one or more processors 120, memory 130, communication interfaces 140, one or more expansion slots 150, and one or more other components 160. Such components and the circuit board 102 can communicate with one another through a bus 104 (e.g., integrated into the circuit board 102).

Processor(s) 120 may be configured to perform the operations in accordance with the instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor (e.g., a central processing unit (CPU) or graphics processing unit (GPU), respectively), digital signal processor, microcontroller, or the like. Memory 130 may be configured to store computer-readable instructions that, when executed by processor(s) 130, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), EEPROM, a flash memory, a dynamic random-access memory (“RAM”), and/or a static RAM. In certain embodiments, memory 130 may include multiple storage devices of various types.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10G Ethernet adaptor, or the like. Wireless links can also be implemented by communication interfaces 140. In such an implementation, communication interfaces 140 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

Controller 110, e.g., BMC, may include a processing unit, internal memory, and communication interfaces, and is configured to monitor and manage the system's hardware components among other things. Controller 110 handles tasks such as remote system management, including hardware health monitoring, system event logging, fault diagnosis and power control. Controller 110 can operate independently of the system's 100 main processor (e.g., processor(s) 120), allowing for out-of-band management. Controller 110 may in certain embodiments facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, and more.

FIG. 2 is a block diagram illustrating an automated testing system 202 for a system 100, in accordance with one or more embodiments in the present disclosure.

As shown in FIG. 2, the testing system 202 includes a database 204 (e.g., production test database), automated test software 206, automated testing programs 208, and test reports 210.

According to embodiments of the present disclosure, the test system 202 is configured to perform automated testing of the system under test (SUT) 218. In some examples, the system under test 218 may be an instance of the system 100 shown in FIG. 1. For example, the SUT 218 may be a server. The SUT 218 can include, among other elements, a controller (e.g., baseboard management controller (BMC)) 214 and an operating system 216. The controller 214 as shown in FIG. 2 is similar to the controller 110 as shown in system 100 of FIG. 1. In some embodiments, the test system 202 may communicate with the controller 214 of the SUT 218 via a network 212 using a communications protocol. For example, the test system 202 may communicate with the controller 214 of the SUT 218 using a wireless network protocol. In other embodiments, the test system 202 may communicate with the controller 214 of the SUT 218 using a local area network (LAN) protocol. In some embodiments, the communications protocol utilized to communicate between the testing system 202 and the controller 214 of the SUT 218 may be, by way of example a simple network management protocol (SNMP), via the network switch 212. The SNMP allows administrators to access and modify configuration and status of the SUT 218 and the test system 202 through the network.

According to embodiments of the present invention, the test system 202 retrieves information, such as identification name (e.g., a unique identification of the SUT 218) and material information, associated with the SUT 218 from the controller 214 using commands, e.g., commands associated with the communications protocol. For example, the identification name of the SUT 218 as retrieved from the controller 214 may include a product name, model, and other identifying information associated with the SUT 218. In some cases, an SNMP command may be used by the test system 202 to obtain the identification name of the SUT 218 from the controller (e.g., BMC) 214. The SNMP command may be, by way of example:
snmpget −v 2c −c <community><BMC_IP><OID_product name>.

Additionally, the test system 202 may obtain material information associated with the SUT 218 from the controller 214 using another command associated with the communications protocol. Material information associated with the SUT 218 may include information related to components, such as a hard disk drive (HDD), dual in-line memory module (DIMM), Peripheral Component Interconnect Express (PCIE) card, installed in the SUT 218. In some cases, an SNMP command may be used by the test system 202 to obtain the expected material information associated with the SUT 218 from the database 204. By way of example, the SNMP command may be:
snmpget −v 2c −c <community><BMC_IP><OID_material information>.

The test system 202 may use the identification name of the SUT 218, retrieved from the controller 214 of the SUT 218, to search for expected material information associated with the SUT 218 in the database 204. In some embodiments, the expected material information associated with the SUT 218, that is stored in the database 204 may include a list of components that are expected to be present in the SUT 218.

The test system 202 compares the material information received from the controller 214 of the SUT 218 a command of a communications protocol (e.g., SNMP command), with the expected material information associated with the SUT 218 retrieved from the database 204 using the identification name of the SUT 218. The results of the comparison are tabulated. The automated test software 206 of the test system 202 performs a verification, e.g., a stock-keeping unit (SKU) verification, based on the tabulated results of the comparison between the material information received from the controller 214 and the material information retrieved form the database 204. In some embodiments, the automated test software 206 may determine whether the material information retrieved from the controller 214 is consistent with the material information retrieved from the database 204. For example, the automated test software 206 may search for components in the material information of the SUT 218 retrieved from the controller 214 that are mentioned in the expected material information retrieved from the database 204. In cases where there is mismatch between the material information obtained from the controller 214 and the material information retrieved from the database 204, the test system 204 records an exception, which may be provided to an operator for processing. For example, if there are excess or reduced materials in the material information received from the controller 214, when compared with the expected material information retrieved from the database 204, the test system may record an exception to be reviewed by an operator.

Using the identification name of the SUT 218, the test system 202 retrieves test projects associated with the SUT 218 from the database 204. In some alternate embodiments, the test projects may be stored in the automated test program 208 of the test system 202. The retrieved test projects are executed in sequence or in parallel by the test system 202 to test the various hardware components of the SUT 218. For example, the retrieved test projects may include memory tests, hard disk tests, PCIE card tests, among other tests. A suitable tool, such as a memtest tool, may be used to perform memory tests on a memory associated with the SUT 218. Other tools, such as Self-Monitoring, Analysis, and Reporting Technology (SMART) tools may be used to perform health checks and performance tests on the hard disk associated with the SUT 218. Driver and test tools may be used to test the function and performance of the PCIE card.

The test system 202 may organize the test projects into test plans. For example, a test plan can include a plurality of individual tests for different components of the SUT 218 as retrieved from the controller 214. The test plans are executed to test the various components of the SUT 218. Once the test plans are executed, the test results records are recorded in log files. According to embodiments of the present disclosure, the log files including the test results may be stored in test reports 210. The recorded test results are compared with expected test results. In some embodiments, the comparison of the test results may yield error messages which may be provided to an operator for analysis and, if necessary, rectification.

After the execution of the test plans is completed, the test system 202 writes the test completion status and time to the controller 214 of the SUT 218 through communication protocols commands (e.g., SNMP commands). In certain embodiments, test completion status and time may be encrypted before they are written to the controller 214 of the SUT 218. In some cases, the encrypted test completion time and status may be written to the controller 214 using an SNMP command. By way of example, the SNMP command may be:
snmpset −v 2c −c <community><BMC_IP><OID_encrypted information of test completion>

Recording the test completion time and status at the controller 214 prevents unauthorized tampering of the test results, ensures data integrity, and supports auditability of the test results. For example, verifying the completion status and time ensures the completeness of the testing process, avoiding inconsistencies caused by unfinished tests or erroneous records. The completion status and time also provide a timestamp and status marker for the test results, enabling subsequent audits or troubleshooting to trace back to the specific completion time and confirm whether the test was properly finalized.

In some cases, each test of the test plan can have a completion time and status associated with it, which is encrypted and written at the controller 214. In some examples, the completion status can be an overall assessment of the test process of the executed test plan, indicating whether the executed test plan was successfully completed (e.g., “Pass” or “Fail”). The test completion time is a timestamp marking the final end of the testing process of the test plan, ensuring traceability of the timeline of the execution of the test plan.

In some embodiments, the test results of the executed test plans are stored in the database 204. In some embodiments, test results are the detailed data generated after the execution of each test of the executed test plans. For example, the test results include whether the test passed, specific test parameters, performance metrics, and any identified errors or anomalies for every test in the test plan. These results provide a comprehensive record of the details and an audit trail of the execution of the tests that are part of the test plan. Along with the test results, a reference value for completion time and status for each test of the plurality of tests of the test plan are also stored in the database 204. Additionally, overall reference values of completion time and status for the test plan are included with the test results. The overall reference values can indicate when the entire test plan including the plurality of tests is completed and the completion status of the entire test plan.

After the encrypted test completion status and time is written to the controller 214, the test system 202 generates detailed test reports where the detailed test report includes test items, test results, comparison results, and exception information, among other items. The detailed test report that is generated by the test system 202 is saved in the database 204 for subsequent query and analysis. In some embodiments, before generating the detailed test report, the test system 202 performs a verification of the test results. In order to perform the verification of the test results, the test system 202 retrieves the test completion status and time stored at the controller 214. In some examples, the test system 202 obtains the test completion status and time from the controller 214 using SNMP commands. By way of example, the SNMP command may be:
snmpset −v 2c −c <community><BMC_IP><OID_encrypted information of test completion>

The retrieved test completion status and time are decrypted and compared with the reference values of test completion status and time that are stored in the database 204. In case the retrieved test completion status and time match the reference completion status and time, the test system logs the successful validation in the database 204 and updates the status of the test results as verified. In case the test completion status and time values that are retrieved from the controller 204 do not match the reference completion status and time values stored in the database 204, the test system 202 flags the error, generates an exception report, and notifies the operators to investigate further and resolve the issue. In some embodiments, each test result of each test of the plurality of tests of the test plan are verified individually, as described above. Once each individual test result is verified, the overall test results of the test plan are then verified. After the test results are verified, the test system 202 terminates the testing process of the test plan.

Once the test results are verified, the test system 202 generates a detailed test report. In some embodiments, the detailed test report that is generated by the test system 202 is stored in the database 204. In some embodiments, the detailed test report includes a summary of the results for all test items, the overall completion time, and the final completion status, making it convenient for operators or engineers to query and analyze. In some cases, the test results of each individual test of the plurality of tests of the test plan are used to generate the detailed test report.

In some embodiments, if an abnormal situation is detected during the execution of the system, such as material inconsistency or test failure, the exception is recorded and an operator associated with the SUT 218 is notified. In such cases, operators can query abnormal information through the database 204 and handle it accordingly. For example, operators can query abnormal information through the database 204 and take corresponding measures, such as retesting and material replacement. In other cases, an operator may attempt to remotely correct any failures of the SUT 218 via the test system 202 or other suitable device.

After the testing of the SUT 218 is completed, the test system 202 will be cleaned up and shut down, including: releasing occupied system resources and memory, turning off the network communication module and encryption module to ensure data security, and recording the system shutdown status and time for subsequent query and analysis.

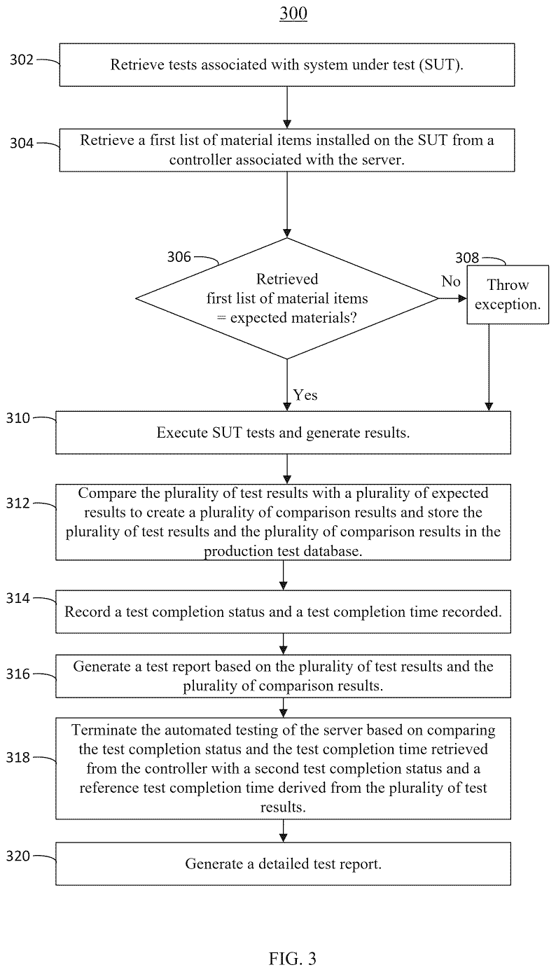

FIG. 3 illustrates a method 300 for automated testing of systems, in accordance with one or more embodiments of the present disclosure. Method 300 may be performed by controller 110 as illustrated in FIG. 1, test system 202 as illustrated in FIG. 2 or other suitable control devices. Method 300 may be performed alone or in combination with other processes in the present disclosure. It will be recognized that method 300 may be performed in any suitable environment and in any suitable order except where otherwise apparent. Alternative steps may be performed instead of or in addition to those shown, and some steps may be omitted entirely. In certain embodiments, the controller 110 can be implemented as the test system 202.

According to embodiments of the present disclosure, the automated testing system 202 may be used to perform automated testing of a server.

At 302, the test system 202 extracts a plurality of system tests (e.g., server tests) associated with the system (e.g., server) from a database (e.g., production test database) using a communication protocol. According to embodiments of the disclosure, the test system 202 may retrieve an identification name from a controller (e.g., BMC) associated with a system under test (SUT) 218. The retrieved identification name may be used to query a database 204 (e.g., production testing database) associated with the testing system 202 to retrieve the plurality of server tests. In some cases, the test system 202 retrieves the identification name and material information associated with the SUT 218 from the controller 214 using commands associated with the communications protocol (e.g., SNMP).

At 304, the test system 202 retrieves a first list of material items installed on the server from a controller associated with the server. In some embodiments, the test system 202 may obtain material information associated with the SUT 218 from the controller 214 using another command associated with the communications protocol (e.g., SNMP). For example, material information associated with the SUT 218 may include information related to components, such as by way of example, a hard disk drive (HDD), dual in-line memory module (DIMM), Peripheral Component Interconnect Express (PCIE) card, installed in the SUT 218.

At 306, the test system 202 determines whether retrieved first list of material items installed on the server match a second list of expected material items associated with the server. For example, test system 202 compares the material information received from the controller 214 of the SUT 218 by a command of a communications protocol (e.g., SNMP command), with the expected material information associated with the SUT 218 retrieved from the database 204 using the identification name of the SUT 218. The results of the comparison are tabulated. In some embodiments, automated test software 206 may determine whether the material information retrieved from the controller 214 is consistent with the material information retrieved from the database 204. For example, the automated test software 206 may search for components in the material information of the SUT 218 retrieved from the controller 214 that are mentioned in the expected material information retrieved from the database 204.

In cases where there is mismatch between the material information obtained from the controller 214 and the material information retrieved from the database 204, the test system 204 proceeds to 308 where the test system 204 records an exception that is provided to an operator for processing. For example, if there are excess or reduced materials in the material information received from the controller 214, when compared with the expected material information retrieved from the database 204, the test system may record an exception at 308 to be reviewed by an operator. In some embodiments, once the exception is recorded at 308, the method 300 moves to 310 where the test system executes each server test of the plurality of server tests to generate a plurality of test results. In some embodiments, the test system 204 may execute tests for those elements that are common in the material information retrieved from the controller 214 and the expected material information retrieved from the database 202.

Alternatively, if, according to some embodiments, the material information received from the controller 214 the same as the expected material information retrieved from the database 204, the method 300 moves to 310 to execute the related tests.

At 312, the test system 202 compares the plurality of test results with a plurality of expected results to create a plurality of comparison results and store the plurality of test results and the plurality of comparison results in the database 204. In some embodiments, the test plans are executed, the test results records are recorded in log files. According to embodiments of the present disclosure, the log files including the test results may be stored in test reports 210. The recorded test results are compared with expected test results. In some embodiments, the comparison of the test results may yield error messages which may be provided to an operator for consideration and rectification.

At 314, the test system 202 records a test completion status and a test completion time recorded. In some embodiments, after the execution of the test plans is completed, the test system 202 writes the encrypted test completion status and time to the controller 214 of the SUT 218 through communication protocols commands (e.g., SNMP commands). This ensures that test results are secure and tamper-proof, preventing unauthorized modification of the test results.

At 316, the test system 202 generates a test report based on the plurality of test results and the plurality of comparison results.

At 318, the test system 202 terminates the automated testing of the server based on comparing the test completion status and the test completion time retrieved from the controller (e.g., BMC) with a second test completion status and a reference test completion time derived from the plurality of test results. For example, during the testing process, the system 202 compares the test completion status and time retrieved from the controller 214 with a reference test completion status and time derived from the multiple test results and stored in the database 204. When the comparison shows that they match, the system will use this to terminate the automated testing process. This ensures the integrity and accuracy of the testing process, preventing any tests that have not been fully completed from being mistakenly considered finished.

At 320, the test system 202 generates a detailed test report. In some embodiments, detailed test report includes test items, test results, comparison results, and exception information, among other items. The detailed test report that is generated by the test system 204 is saved in the database 204 for subsequent query and analysis.

It is noted that the techniques described herein may be embodied in executable instructions stored in a non-transitory computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. The elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method to perform automated testing of a server, comprising:
retrieving a plurality of server tests associated with the server from a database;
retrieving a first list of material items installed on the server from a controller associated with the server;
executing each server test of the plurality of server tests to generate a plurality of test results;
comparing the plurality of test results with a plurality of expected results to create a plurality of comparison results;
storing the plurality of test results and the plurality of comparison results in the database;
generating a test report based on the plurality of test results and the plurality of comparison results; and
terminating the automated testing of the server based on a test completion status and a test completion time recorded at the controller.

2. The method of claim 1, wherein extracting the plurality of server tests comprises:
obtaining a server identifier for the server from the controller; and
querying the database using the obtained server identifier to extract the plurality of test results.

3. The method of claim 2, wherein the obtaining the server identifier from the controller comprises:
sending an SNMP request to the controller for the server identifier; and
receiving an SNMP response from the controller including the server identifier.

4. The method of claim 2, wherein retrieving the first list of material items installed on the server comprises:
querying the database using the retrieved server identifier to retrieve a second list of expected material items associated with the server; and
generating a material items report based on comparing the first list of material items installed on the server with the second list of expected material items.

5. The method of claim 4, wherein the material items report comprises inconsistencies between the first list of material items installed on the server and the second list of expected material items, and wherein an exception is generated based on the inconsistencies.

6. The method of claim 1, wherein retrieving the first list of material items installed on the server from controller associated with the server comprises:
sending an SNMP request to the controller for the first list of materials installed on the server; and
receiving an SNMP response from the controller including the first list of materials installed on the server.

7. The method of claim 1, wherein the test completion status and the test completion time are recorded at the controller by:
encrypting the test completion status and the test completion time; and
sending an SNMP recordation request to the BMC that comprises the encrypted test completion time and the encrypted test completion status.

8. The method of claim 7, wherein terminating the automated testing of the server comprises:
retrieving, using an SNMP command, the test completion status and the test completion time stored at the controller; and
terminating the automated testing of the server based on comparing the test completion status and the test completion time retrieved from the controller with a reference test completion status and a second test completion time derived from the plurality of test results.

9. The method of claim 1, wherein the controller is a baseboard management controller (BMC).

10. A system to perform automated testing of a server, the system comprising:
a controller configured to:
retrieve a plurality of server tests associated with the server from a database;
retrieve a first list of material items installed on the server from a controller associated with the server;
execute each server test of the plurality of server tests to generate a plurality of test results;
compare the plurality of test results with a plurality of expected results to create a plurality of comparison results;
store the plurality of test results and the plurality of comparison results in the database;
generate a test report based on the plurality of test results and the plurality of comparison results; and
terminate the automated testing of the server based on a test completion status and a test completion time recorded at the controller.

11. The system of claim 10, wherein the controller configured to extract the plurality of server tests, is further configured to:
obtain a server identifier for the server from the controller; and
query the database using the obtained server identifier to extract the plurality of test results.

12. The system of claim 11, wherein the controller configured to obtain the server identifier from the controller, is further configured to:
send an SNMP request to the controller for the server identifier; and
receive an SNMP response from the controller including the server identifier.

13. The system of claim 11, wherein the controller configured to retrieve the first list of material items installed on the server, is further configured to:
query the database using the retrieved server identifier to retrieve a second list of expected material items associated with the server; and
generate a material items report based on comparing the first list of material items installed on the server with the second list of expected material items.

14. The system of claim 13, wherein the material items report comprises inconsistencies between the first list of material items installed on the server and the second list of expected material items, and wherein an exception is generated based on the inconsistencies.

15. The system of claim 14, wherein the controller configured to retrieve the first list of material items installed on the server from controller associated with the server, is further configured to:
send an SNMP request to the controller for the first list of materials installed on the server; and
receive an SNMP response from the controller including the first list of materials installed on the server.

16. The system of claim 10, wherein the controller configured to record the test completion status and the test completion time is further configured to:
encrypt the test completion status and the test completion time; and
send an SNMP recordation request to the BMC that comprises the encrypted test completion time and the encrypted test completion status.

17. The system of claim 16, wherein the controller configured to terminate the automated testing of the server, is further configured to:
retrieve, using an SNMP command, the test completion status and the test completion time stored at the controller; and
terminate the automated testing of the server based on comparing the test completion status and the test completion time retrieved from the controller with a reference test completion status and a second test completion time derived from the plurality of test results.

18. The method of claim 1, wherein the controller is a baseboard management controller (BMC).

19. A tangible, non-transitory computer-readable medium to perform automated testing of a server, the computer-readable medium having instructions thereon, which, upon being executed by one or more processors, provides for execution of the following steps:
retrieving a plurality of server tests associated with the server from a database;
retrieving a first list of material items installed on the server from a controller associated with the server;
executing each server test of the plurality of server tests to generate a plurality of test results;
comparing the plurality of test results with a plurality of expected results to create a plurality of comparison results;
storing the plurality of test results and the plurality of comparison results in the database;
generating a test report based on the plurality of test results and the plurality of comparison results; and
terminating the automated testing of the server based on a test completion status and a test completion time recorded at the controller.

20. The method of claim 19, wherein extracting the plurality of server tests comprises:
obtaining a server identifier for the server from the controller; and
querying the database using the obtained server identifier to extract the plurality of test results.
